(19) United States
(12) Patent Application Publication
(10) Pub. No.: US 2025/0209713 A1
(43) Pub. Date: Jun. 26, 2025

(54) METHOD AND DEVICE FOR GENERATING DIGITAL HUMAN FACIAL EXPRESSIONS AND FACIAL EXPRESSION MODEL AND PLUG-IN SYSTEM OF VR DEVICE

(71) Applicant: WODEN TECHNOLOGY COMPANY LIMITED, HK (CN)

(72) Inventor: Yue ZHANG, Beijing (CN)

(73) Assignee: WODEN TECHNOLOGY COMPANY LIMITED, HK (CN)

(21) Appl. No.: 19/080,533

(22) Filed: Mar. 14, 2025

Related U.S. Application Data
(63) Continuation of application No. PCT/CN2022/123698, filed on Oct. 4, 2022.

(30) Foreign Application Priority Data
Sep. 14, 2022 (CN) 202211111781.2

(51) Int. Cl. G06T 13/40; G06V 10/54; G06V 10/74; G06V 10/75; G06V 10/766; G06V 10/77; G06V 10/774; G06V 40/16

(52) U.S. Cl. CPC G06T 13/40; G06V 10/54; G06V 10/7553; G06V 10/7557; G06V 10/761; G06V 10/766; G06V 10/77; G06V 10/774; G06V 40/171; G06V 40/174

(57) ABSTRACT

The present disclosure provides a method and device for generating digital human facial expressions and models. The method for generating digital human facial expressions comprises capturing a performer's facial expression video; selecting a plurality of frames or all frames from the facial expression video and fitting each selected frame by using an active appearance model to obtain a plurality of facial marks; calculating values of controllers for driving expressions of 3D model of a digital human, based on the plurality of facial marks obtained from each selected frame and a pre-determined mapping relationship from facial expressions to the 3D model of the digital human. The method of the present disclosure utilizes both the shape information and the statistical analysis for the texture information, constructing a hybrid model that interconnects shape and texture, and thus achieves improved fitting accuracy.

### CROSS-REFERENCE TO RELATED APPLICATIONS

The application claims priority to Chinese patent application No. 202211111781.2, filed on Sep. 14, 2022, the entire contents of which are incorporated herein by reference.

### TECHNICAL FIELD

The present disclosure relates to capture and image processing of human facial expressions, and specifically, to a method and device for generating digital human facial expressions and facial expression model, and a plug-in system of VR device.

### BACKGROUND

Industries, such as film/television, gaming, advertising, new media, and virtual reality require the use of a large number of realistic virtual humans constructed from three-dimensional data. Facial expressions are the primary medium for conveying human emotions, with the subtlety of movement and amplitude playing a role in emotional transmission. The accuracy and precision of facial expression tracking directly affect the authenticity of virtual human control.

Transferring a performer's (or user's) facial expression animation to a virtual human model currently demands labor-intensive manual modeling and animation refinement to achieve realistic expressions. This process is time-consuming and expensive. If deep neural networks are used for training generalized models, the computational load is significant, requiring high hardware specifications and long computation times.

Additionally, traditional VR (Virtual Reality) devices have issues in social and facial expression interaction games, such as stiff facial expressions, a lack of realism, and insufficient smoothness, resulting in an unsatisfactory user experience.

### SUMMARY

The present disclosure provides a method and device for generating digital human facial expressions, and a method for generating a facial expression model for digital humans for achieving the tracking and transfer of facial expressions. It further provides a plug-in system for VR devices that can be connected to existing VR devices to track human facial expressions.

To address at least one of the above technical problems, according to the first aspect of the present disclosure, a method for generating a digital human facial expression model is provided. The method comprises training a shape model and a texture model based on a plurality of facial marks annotated in a training set, obtaining a regression matrix through perturbation experiments, wherein the regression matrix represents a relationship between parameter variations obtained from the perturbation experiments and texture residual(s). The training set comprises a plurality of images containing human facial expressions as keyframes. The method further comprises adjusting the values of controllers corresponding to the facial expression of each keyframe to obtain a digital human expression with high similarity; wherein the controllers are used to control the expression of 3D model of the digital human; and determining a mapping relationship from the facial expression to the 3D model of the digital human, based on the adjusted values of the controllers and coordinates of the annotated facial marks.

In some exemplary embodiments according to the first aspect, the perturbation experiments comprise variations in the perturbation values of scaling factor, in the perturbation values of rotation angle, in the perturbation values of translation, in the perturbation values of shape parameters of shape model, and in the perturbation values of parameters of texture model.

$${\underbrace{[ \begin{matrix}{φ}_{11} & {φ}_{12} & … & {φ}_{1 N} \\ {φ}_{21} & {φ}_{22} & … & {φ}_{2 N} \\ ⋮ & ⋮ & & ⋮ \\ {φ}_{11} & {φ}_{12} & … & {φ}_{1 N}\end{matrix} ]}}_{Φ} {\underbrace{[ \begin{matrix}{w}_{1} \\ {w}_{2} \\ ⋮ \\ {w}_{N}\end{matrix} ]}}_{w} = {\underbrace{[ \begin{matrix}{y}_{1} \\ {y}_{2} \\ ⋮ \\ {y}_{N}\end{matrix} ]}}_{y}$$

In some exemplary embodiments according to the first aspect, determining, based on the adjusted values of the controllers and the coordinates of the annotated facial marks, a mapping relationship from the facial expression to the 3D model of the digital human comprises using the following equation for fitting:

Wherein φ is a basis function, with φⱼᵢ=φ(∥xⱼ−xᵢ∥), x denotes the coordinates of the plurality of facial marks, N is number of keyframes, and y denotes the values of the controllers. By solving the above equation, a set of weights w is obtained for each keyframe, and the weights obtained for the plurality of keyframes are used as the mapping relationship from the facial expression to the 3D model of the digital human.

In some exemplary embodiments according to the first aspect, the training set comprises the keyframes selected from the previously acquired facial expression videos. In some exemplary embodiments according to the first aspect, the step of training the shape model comprises aligning the coordinates of the facial marks in the training set with an average reference mark and performing principal component analysis on the transformed training set to obtain the shape model.

In some exemplary embodiments according to the first aspect, the average reference mark is obtained by: (1) calculating initialized average reference marks; (2) aligning the facial marks in the training set with the average reference marks and averaging the aligned facial marks to obtain updated average reference marks; iterating step (2) until error between the facial marks in the training set and the average reference marks falls within a tolerant range.

According to a second aspect of the present disclosure, a method for generating digital human facial expressions is provided. The method comprises capturing a facial expression video of a performer; selecting a plurality of frames or all frames from the facial expression video and performing fitting by using an active appearance model to obtain a plurality of facial marks for each selected frame; calculating values of controllers for driving the facial expressions of 3D model of a digital human based on facial marks obtained for each frame and a pre-determined mapping relationship from facial expressions to the 3D model; wherein obtaining the active appearance model comprises the following steps: training a shape model and a texture model based on facial marks annotated in a training set, and obtaining a regression matrix through perturbation experiments, where the regression matrix represents the relationship between parameter variations obtained through the perturbation experiments and texture residual(s). The training set comprises a plurality of images containing human facial expressions.

In some exemplary embodiments according to the second aspect, the step of obtaining the mapping relationship from the facial expressions to the 3D model of the digital human comprises: adjusting the values of the controllers for each facial expression in the training set to obtain a corresponding digital human expression with high similarity; obtaining the mapping relationship from the facial expressions to the 3D model based on the adjusted values of the controllers and coordinates of the annotated facial marks in the training set.

In some exemplary embodiments according to the second aspect, the step of performing fitting by using the active appearance model to obtain the plurality of the facial marks for each selected frame comprises: (1) obtaining texture features based on given initialization reference marks; (2) calculating difference between the texture features and the average texture features as texture residual(s), and adjusting parameters of the texture model to obtain new average texture features; (3) determining a parameter variation matrix based on the regression matrix and the texture residual(s), to derive shape parameters and new texture features, iterating steps (2) and (3) until the texture residual(s) exceed a predetermined threshold or maximum number of iterations is reached, then terminate the iteration.

In some exemplary embodiments according to the second aspect, the parameters of the texture model are adjusted using texture model equation as follows:

$$g = \overline{g} + {ϕ}_{g} {b}_{g}$$

Wherein g is the texture feature, g̅ is the average texture feature, Φ_{g} is the basis vector of the texture feature space, and b_{g} is the eigenvalue of the texture feature model.

In some exemplary embodiments according to the second aspect, the step of calculating the values of the controllers for driving the facial expressions of the 3D model comprises substituting coordinates of the plurality of the facial marks into the following equation to obtain the values of the controllers:

$${\underbrace{[ \begin{matrix}{φ}_{11} & {φ}_{12} & … & {φ}_{1 N} \\ {φ}_{21} & {φ}_{22} & … & {φ}_{2 N} \\ ⋮ & ⋮ & & ⋮ \\ {φ}_{11} & {φ}_{12} & … & {φ}_{1 N}\end{matrix} ]}}_{Φ} {\underbrace{[ \begin{matrix}{w}_{1} \\ {w}_{2} \\ ⋮ \\ {w}_{N}\end{matrix} ]}}_{w} = {\underbrace{[ \begin{matrix}{y}_{1} \\ {y}_{2} \\ ⋮ \\ {y}_{N}\end{matrix} ]}}_{y}$$

Whereinφ is a basis function, φⱼᵢ=φ(∥xⱼ−xᵢ∥), x is the coordinates of the facial marks, N is number of selected frames, and y is the values of the controllers. The weights w are pre-calculated using the equation based on the annotated facial marks in the training set as the mapping relationship from the human facial expression to the 3D model.

In some exemplary embodiments according to the second aspect, the plurality of images contained in the training set are selected from a pre-obtained facial expression video as keyframes.

According to a third aspect of the present disclosure, a computer-readable storage medium is provided, on which a computer program is stored. When the program is executed by a processor, it implements the method for generating a digital human facial expression model according to the first aspect or the method for generating digital human facial expressions according to the second aspect.

According to a fourth aspect of the present disclosure, a device for generating digital human facial expressions is provided. The device comprises a camera for capturing a performer's facial expression video; a video capture controller for receiving the captured video from the camera and sending capture instructions to the camera; a processor; and a memory storing a computer program. The computer program comprises instructions that, when executed by the processor, implement the method for generating a digital human facial expression model according to the first aspect or the method for generating digital human facial expressions according to the second aspect.

According to a fifth aspect of the present disclosure, a plug-in system for a VR device is provided. The system comprises a first set of cameras facing user's eyes, where the first set of cameras comprises at least two cameras with infrared functionality; a second set of cameras facing the user's mouth, where the second set of cameras comprises one or more cameras; a first set of infrared LED lights arranged near the first set of cameras; a connection structure configured to attach the plug-in system to the VR device; a synchronization controller configured to receive facial expression data from the first and second sets of cameras and send synchronization signals for simultaneous image capture to the first and second sets of cameras; a processor; and a memory storing a computer program, wherein the program, when executed by the processor, implements the method for generating a digital human facial expression model according to the first aspect or the method for generating digital human facial expressions according to the second aspect.

### BRIEF DESCRIPTION OF DRAWINGS

To more clearly illustrate the technical solutions of the embodiments of the present disclosure, the accompanying drawings of the embodiments are briefly described below. The drawings illustrate specific embodiments of the present disclosure and are provided for explanatory purposes only; they are not intended to define or limit the scope of the disclosure.

FIG. 1 is a flowchart illustrating modeling steps for transferring a performer's facial expressions to a digital human model according to an embodiment of the present disclosure.

FIG. 2 is a flowchart illustrating an exemplary method for real-time transfer of a performer's facial expressions to a digital human according to an embodiment of the present disclosure.

FIG. 3 is a schematic diagram illustrating part of a digital human rigging scheme according to an embodiment of the present disclosure.

FIG. 4 is a schematic diagram illustrating the mark annotation method for keyframes according to an embodiment of the present disclosure.

FIG. 5 is a schematic diagram illustrating a device for generating digital human facial expressions by transferring a performer's facial expression video to a 3D model according to an embodiment of the present disclosure.

FIG. 6 is a schematic block diagram of a plug-in system for a VR device according to an embodiment of the present disclosure.

FIGS. 7A and 7B are structural schematic diagrams of a plug-in system for a VR device according to an embodiment of the present disclosure.

FIG. 8 is a schematic diagram of the pre-assembly and post-assembly states of the plug-in system shown in FIGS. 7A and 7B provided on a virtual reality device.

### DETAILED DESCRIPTION OF THE EMBODIMENTS

To make the objectives, technical solutions, and advantages of the embodiments of the present disclosure clearer, the following is a detailed description of the technical solutions of the embodiments of the present disclosure with reference to the accompanying drawings. It is obvious that the described embodiments are only part of the embodiments of the present disclosure, and not all of them. Different embodiments can be combined with each other to form other embodiments not shown in the following description. Based on the described embodiments of the present disclosure, all other embodiments obtained by those of ordinary skill in the art without creative effort fall within the scope of the present disclosure.

Unless otherwise defined, technical or scientific terms used herein shall have the ordinary meanings understood by those of ordinary skill in the art to which the present disclosure pertains. The terms “first,” “second,” and similar expressions used in the specification and claims of this patent application do not denote any order, quantity, or importance but are merely used to distinguish between different components. Similarly, terms such as “a” or “an” do not necessarily impose a quantity limitation. The terms “comprises,” “comprising,” or similar expressions mean that the element or item preceding such terms comprises the elements or items listed thereafter and their equivalents, without excluding other elements or items. The terms “connected,” “coupled,” or similar expressions are not limited to physical or mechanical connections but may comprise electrical connections, whether direct or indirect. Terms such as “upper,” “lower,” “left,” “right,” or the like are used solely to describe relative positional relationships; when the absolute position of the described object changes, such relative positional relationships may correspondingly change.

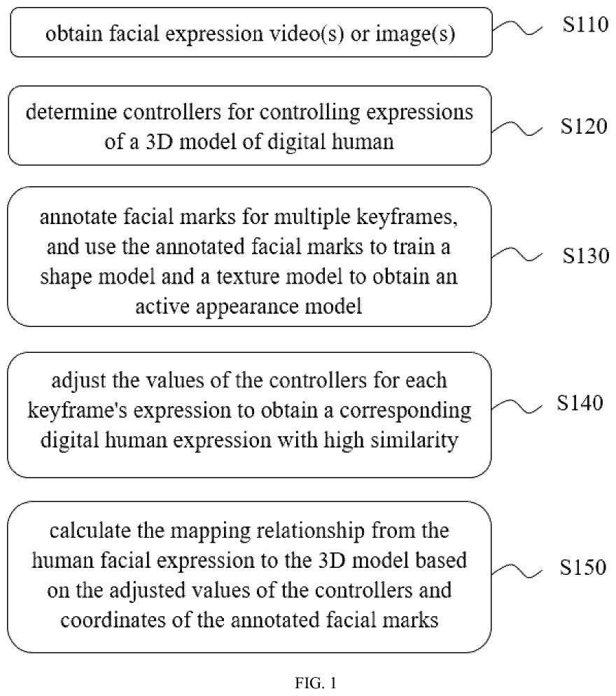

FIG. 1 shows a flowchart of modeling steps for transferring a performer's facial expressions to a 3D model according to an embodiment of the present disclosure. The order of the steps may not necessarily be the same as the order shown in FIG. 1, unless explicitly required. For example, S120 may be executed before S110.

In step S110, a video of the performer's face is recorded, including dozens to hundreds of expressions, such as happiness, anger, sadness, joy, laughter, smiles, and grins. The number and position of the cameras may be adjusted in advance as needed. A single camera may be used to capture the face, or two or more cameras may be used to capture the face from different angles. Alternatively, one or more cameras may be positioned near the eyes and mouth, respectively, to obtain more detailed information. For example, when used with VR devices, to obtain more detailed expression information, a plurality of cameras may be set up around the eyes and mouth. The cameras may capture video of the performer or capture images containing expressions.

In step S120, controllers for controlling facial expressions of the 3D model (also referred to as the face rigging solution of the digital human) are determined. The scheme may comprise controllers (hereinafter denoted as Q for the number of controllers). The values of the controllers may be described using floating-point values to indicate the intensity of a specific expression (such as an expression of a particular facial region) of the digital human. For example, the value of each controller may range from 0.0 to 1.0. Values of a set of controllers may be used to represent a specific expression of the digital human.

For example, the face rigging solution for the digital human may be implemented as follows. First, the key expressions of the digital human, defined by the Facial Action Coding System (FACS) are scanned, and these FACS key expressions are converted into the digital human's blendshapes. The value of each blendshape corresponds to the value of a controller.

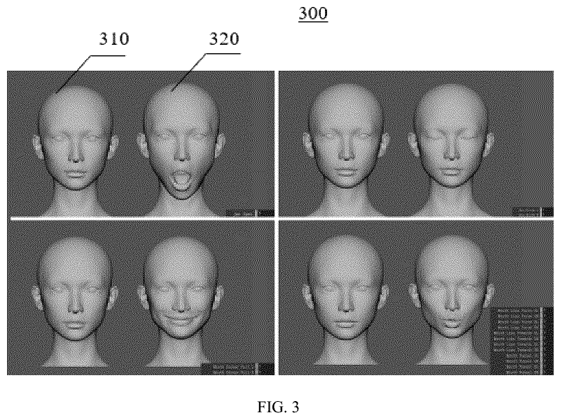

FIG. 3 illustrates of the key expressions of the digital human's face 300 according to an embodiment of the present disclosure. For example, the upper left image shows a specific expression with the mouth open. In FIG. 3, the left image of each pair of images represents a neutral expression (e.g., expression 310), and its blendshape value that may be set to 0, while the right image is the key expression (e.g., expression 320), and its blendshape value may be set to 1. For a specific expression, the closer the blendshape value is to 1, the closer it is to the key expression. When applying this method to VR devices, existing rigging solution of the VR device may be used, for example, an expression control solution based on MetaHuman or the standard expression control solution based on Apple's ARKit, or other custom rigging solutions.

In step S130, facial mark positions and identifiers are annotated on a plurality of keyframes (hereinafter denoted as N, representing the number of keyframes) extracted from the video recorded in step S110 to generate a training set. The training set comprises a plurality of keyframes selected from the expression video that have been annotated, forming an annotated image set. If static facial expression images rather than a video are captured, some expression images are selected as keyframes, and the facial mark positions and identifiers are annotated on the selected images to obtain the training set.

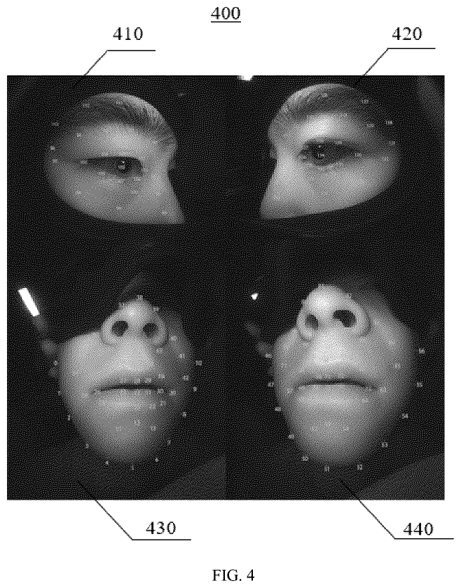

An example of annotating the mark positions and identifiers of keyframes may be seen in FIG. 4. FIG. 4 shows a keyframe obtained from videos captured simultaneously by four cameras at different angles while a performer wears a VR device. Two cameras capture the images of the eye regions to obtain images 410 and 420, and two cameras capture the images of the mouth region to obtain images 430 and 440. The keyframe includes a composite facial image formed by combining these four images. The mark positions and identifiers may be annotated manually. Other keyframes may be annotated in the same way.

After annotating each keyframe, modeling is performed on all or specific marks. Modeling may be performed on only one type of marks, such as marks corresponding to only the lip, or may be performed for a plurality of types of marks. By combining the shape model and the texture model, an active appearance model (AAM) is established, which allows the model to reflect both shape variations and global texture variations. The modeling process mainly comprises training the shape model, training the texture model, and determining the regression matrix through perturbation experiments.

Training the shape model comprises aligning the mark coordinates of each image in the training set with the average reference marks, which may be achieved through a plurality of iterations of Procrustes analysis; performing principal component analysis on the aligned training set to obtain the shape model. The average reference marks may be obtained as follows: (1) using the mean value method to obtain the initialized average reference marks; (2) aligning all the key points (i.e., the marks used for modeling) in the training set with the average reference marks and averaging the aligned key points of all images in the training set to obtain the updated average reference marks; iterating step (2) until the error between the key points in the training set and the average reference marks falls within a tolerance range.

Training the texture model comprises connecting the marks of each image in the training set into a plurality of small triangles according to a preset triangulation scheme; performing texture warping by applying affine transformations to corresponding small triangles between the training set images and the average reference marks. The texture model is independent of the shape model.

The perturbation experiments may comprise various types of perturbation variations, such as variations in the perturbation values of scaling, in the perturbation values of rotation angle, in the perturbation values of translation, in the perturbation values of shape parameters of shape model, and in the perturbation values of parameters of texture model. During the aforementioned experiments, the parameter variation matrix Δp and the texture residual matrix Δg are retained, and the relationship between the parameter variation matrix and the texture residual matrix is defined as a regression matrix R, where Δp=RΔg.

To reduce computational overhead and conserve memory usage, the Jacobian matrix J may be utilized to assist the calculation:

$$J = \frac{\partial Δ g}{\partial Δ p} \qquad ( 1 )$$

$$R = {( {J}^{T} J )}^{- 1} {J}^{T} = {J}^{†} \qquad ( 2 )$$

The regression matrix R contains information on how to correct the model parameters based on the texture residuals.

Through the above steps, the active appearance model that comprises both the shape model and the texture model is obtained, which reflects variations in both shape and global texture.

Steps S140-S150 are used to determine the mapping relationship for fitting facial expressions to the 3D model of the digital human.

In step S140, for the expressions of the N keyframes, Q controllers determined in step S120 are adjusted to generate R expressions with relatively high similarity to the performer's expressions. Finally, N*Q controller values are obtained.

In step S150, for the N keyframes, the coordinates of the annotated F facial marks are used to produce N×F mark data. Based on the values of Q controllers and the coordinates of the facial marks corresponding to the N keyframes, the mapping relationship for fitting facial expressions to the 3D model of the digital human is obtained.

In step S150, the mapping relationship between the facial model space to the target digital human's 3D model space may be fitted using the following RBF (Radial Basis Function) interpolation function:

$$\hat{f} ( x ) = {\sum }_{i = 1}^{N} {w}_{i} φ ( ‖ x - {x}_{i} ‖ ) \qquad ( 3 )$$

Wherein N is the number of keyframes, φ is the basis function, and the basis function may be selected as needed.

For each frame, F pieces of M-dimensional data (where M is the coordinate dimension of each mark) are concatenated into an F×M-dimensional vector x. For instance, two 2D mark P(1.1, 2.1) and P(3.0, 4.0) are combined into the vector x(1.1, 2.1, 3.0, 4.0).

Substituting x into the above Equation (3). For each keyframe, there are values of Q controllers, and the values of the controllers are assigned as y. The weights w may be obtained by solving the following equation:

$${\underbrace{[ \begin{matrix}{φ}_{11} & {φ}_{12} & … & {φ}_{1 N} \\ {φ}_{21} & {φ}_{22} & … & {φ}_{2 N} \\ ⋮ & ⋮ & & ⋮ \\ {φ}_{11} & {φ}_{12} & … & {φ}_{1 N}\end{matrix} ]}}_{Φ} {\underbrace{[ \begin{matrix}{w}_{1} \\ {w}_{2} \\ ⋮ \\ {w}_{N}\end{matrix} ]}}_{w} = {\underbrace{[ \begin{matrix}{y}_{1} \\ {y}_{2} \\ ⋮ \\ {y}_{N}\end{matrix} ]}}_{y} , wherein {φ}_{ji} = φ ( ‖ {x}_{j} - {x}_{i} ‖ ) \qquad ( 4 )$$

The weights w are computed by solving the above equation for each controller, N weights w may be obtained for each controller, resulting in a total of N×Q weights w.

This method not only utilizes the shape information of the target object but also incorporates statistical analysis for the texture information, constructing a hybrid model that interconnects shape and texture. Compared to using only the shape model, this method achieves improved fitting accuracy.

Additionally, different regions of the face (eyes, mouth, face, etc.) may be fully or partially recognized as needed. Since the number and positions of key points on the face may be changed, the training process is flexible and controllable.

The existing deep learning methods for facial mark localization typically downsample input images to extract semantic features and then upsample them to restore resolution, inevitably losing original image information. The method described in this embodiment preserves the original resolution and introduces multi-resolution sub-images, achieving better results with less data.

In the above embodiments, each model may be generated based on the facial expression data of a specific person, making it highly targeted and accurate, with low training data requirements. Testing demonstrates that the model requires only a small number of subject-specific facial expression images (approximately 100 images were used in experiments) to generate corresponding facial texture and shape models, outperforming conventional generalized models in accuracy. Furthermore, the method significantly reduces computational complexity, lowering hardware demands and shortening training time.

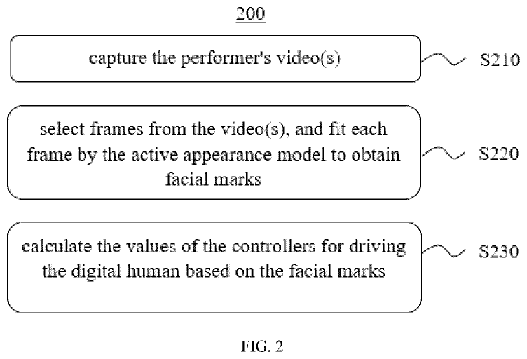

FIG. 2 shows a flowchart of an exemplary method for transferring a performer's facial expressions to a 3D model using the active appearance model obtained by the above algorithm.

In step S210, the performer's facial video is captured by one or more cameras. To enable real-time expression transfer to the 3D model of the digital human, the one or more cameras are configured to acquire the facial video in real-time.

In step S220, the active appearance model trained in step S130 is used to fit each frame within either a selected subset or all frames of the video, thereby obtaining a plurality of facial marks.

The process of fitting using the active appearance model may further comprise the following steps:
(1) After the initial position is given, the texture feature g_image is obtained based on the distribution of the initialization reference marks (e.g., the average reference marks);
(2) The texture residual, i.e., Δg=g_image−g_model, is calculated, where g_model is the average texture feature (denoted by g). During iteration, the texture model parameters b_{g} (represented by the eigenvalue of the texture feature model) are adjusted to update g_model, where the texture model parameter may be adjusted by the following texture model equation:

$$g = \overline{g} + {ϕ}_{g} {b}_{g} \qquad ( 5 )$$

Wherein g is the texture feature (which may be represented by a texture feature vector), Φ_{g} denotes the basis vectors of the texture feature space. The parameters of the texture model may be manipulated, such as setting constraints to limit the shape variations within a reasonable range.

(3) According to the equation Δp=RΔg, Δp is obtained, i.e., the shape parameters of the model and the new texture feature g_image are obtained;

(4) The steps (2) and (3) are repeated until the texture residual exceeds the preset threshold or the maximum iteration count is reached, at which point the iteration terminates. The tracking range corresponding to the current shape parameters is the fitted tracking range, yielding the coordinates of the facial marks for the frame.

In step S220, to reduce the computational complexity, the number of feature vectors of Φ_{g} may be changed through mathematical derivation to obtain a dimension-reduced texture feature space.

In step S230, the facial marks obtained from the frame are substituted into equation (4) along with the weight values w calculated in step S150, outputting values of Q controllers corresponding to the frame. Here, N represents the number of selected frames, not the number of keyframes as in the embodiment shown in FIG. 1. The values of Q controllers are used to drive the digital human's 3D model, thereby obtaining the digital human's expressions.

The above model, through rigorous mathematical derivation, reduces the number of the model parameters used in the fitting process, significantly reducing the computational complexity. During the training process, the parameters may be intervened manually, allowing the shape variations to be constrained within a reasonable range, thereby enhancing robustness.

Since the active appearance model combines the shape model and the texture model, performing fitting by using the active appearance model may obtain more accurate and subtle marks, making the expression mapping of the 3D model more accurate and capable of reflecting micro-expression changes. The model does not require a large training set or time-consuming calculations, and for the specific person corresponding to the model, accurate and fast expression tracking may be achieved. As the number of models increases, new models may be adjusted based on known models, shortening the modeling process and increasing the universality of the models.

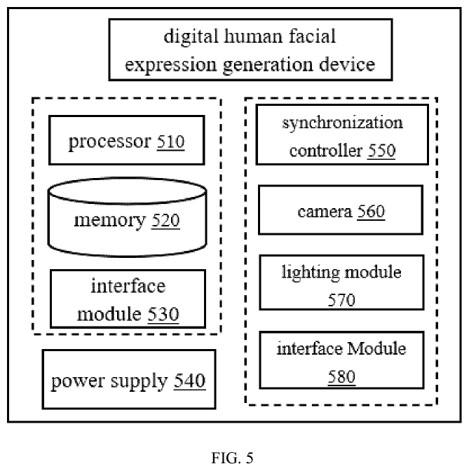

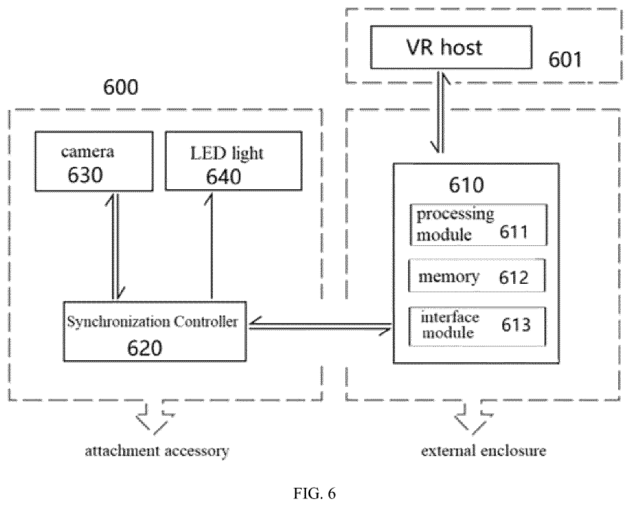

FIG. 5 is a schematic diagram of a digital human facial expression generation device 500 by transferring a performer's facial expression video to a digital human model according to an embodiment of the present disclosure. The digital human facial expression generation device 500 may comprise two parts, where the first part is the main control section, including a processing module 510, a memory 520, and an interface module 530, mainly used for calculating and outputting the values of controllers that drive the 3D model of the digital human based on the obtained performer's video. The second part is the video capture section, including a video capture controller 550, a camera 560, a lighting module 570, and an interface module 580, mainly used for capturing the performer's expressions and transmitting expression data to the processing module in the main control section. The two parts may be configured as two separate modules (as shown in FIG. 6) or as a single unit. The two parts may each have their own power module or share a power module 540. The digital human facial expression generation device 500 may receive or pre-store digital human expression models from a server (not shown) or optionally generate digital human expression models (using the method as shown in FIG. 1). The digital human facial expression generation device 500 may upload captured facial expressions to a server, where the server generates digital human expression models.

The processing module 510 may be used to perform part or all of the digital human facial expression model generation method according to the embodiment shown in FIG. 1 and/or part or all of the digital human facial expression model generation method according to the embodiment shown in FIG. 2. The processing module 510 receives requests from external devices (e.g., VR devices, AR devices, etc.) through the interface module 530 and send the calculated data for driving the digital human's expressions or other requested data to them. The processing module may comprise one or more processors, which may be microprocessors, multi-core processors, application-specific integrated circuits (ASICs), field-programmable gate arrays (FPGAs), or various other processors. In some embodiments (not shown), the processing module may integrate the memory 520 to store instructions for executing the above operations and/or store data. Part or all of the main control section may be arranged together with part or all of the video capture section. For example, when the main control section and the video capture section are configured as a single unit, the video capture controller 550 may also be omitted, and its functions may be performed by the processing module 510 or the processor in the processing module 510. The processing module may also comprise other analog or digital circuits to perform the above operations according to the embodiments of the present disclosure.

The memory 520 may comprise non-volatile storage media for storing instructions for executing the above methods and/or storing data. Optionally, the memory 520 may also store video data captured by the camera 560.

The interface module 530 may comprise one or more wired or wireless data interfaces for sending and receiving data, such as HDMI interfaces, USB interfaces, Bluetooth interfaces, Wi-Fi interfaces, Ethernet interfaces, etc. The interface module 530 may receive requests from external devices, such as requests for expression capture, and send the requested data to them, such as the calculated data for driving the digital human's expressions or the processed expression data. The interface module 530 may be connected to the interface module 580, allowing the processing module 510 to send capture signals or instructions to the video capture controller 550 and to receive captured video data from the video capture controller 550 or the camera 560.

The video capture controller 550 may comprise one or more processors, microprocessors, multi-core processors, ASICs, FPGAs, or other analogous digital/logical circuitry. The video capture controller 550 may be used to send capture signals or instructions to the camera 560 and receive captured video signals. If the camera 560 comprises a plurality of cameras, the video capture controller 550 may send synchronized capture signals to the cameras. The synchronized capture signals may be generated by the video capture controller 550, such as converting a fixed-frequency pulse sent by an external device into a trigger signal for driving the cameras to capture each frame. Optionally, the video capture controller 550 may also convert video signals into signals suitable for transmission through the interface module 580. For example, if the interface module 580 uses a USB interface, the video capture controller 550 may convert video signals into UVC signals to send to the processing module 510. The video capture controller 550 may also control the lighting module 570 to illuminate the face during capture.

The camera 560 may comprise one or more cameras. The camera 560 captures the performer's face, and the captured video comprises at least the expression information around the eyes and/or mouth. For example, the embodiment shown in FIG. 4 uses four cameras, two for capturing the area around the eyes and two for capturing the area around the mouth from different angles. In the case of a plurality of cameras, the camera 560 may receive synchronized capture signals or instructions from the video capture controller 550 for synchronized capture. To track facial expression movements, the frame rate of the camera 560 may be no less than 30 frames per second. In darker environments, infrared cameras may be used.

The lighting module 570 may comprise one or more LED lights or similar components, placed near the camera 560 to illuminate the face. In low-light environments, the lighting module 570 may comprise infrared LED lights to illuminate the face without causing glare.

The interface module 580 may comprise one or more wired or wireless data interfaces for sending and receiving data, such as HDMI interfaces, USB interfaces, Bluetooth interfaces, Wi-Fi interfaces, Ethernet interfaces, etc. If the main control section and the video capture section are configured as a single unit, the interface module 580 may be omitted.

FIG. 6 shows a schematic block diagram of a plug-in system for a VR device according to an embodiment of the present disclosure. The circuit portion 600 of the plug-in system has a similar circuit logic structure to the digital human facial expression generation device 500 shown in FIG. 5, but the circuit portion 600 is adapted for use in VR devices. The circuit portion 600 of the plug-in system may be connected to a VR host 601 via wired or wireless means, receiving requests or commands from the VR host 601—such as expression capture requests—and sending data for driving the digital human's expressions or other requested data. The circuit portion 600 of the plug-in system may also send the captured performer's video to a server (not shown) and receive or pre-store digital human facial expression models from the server (which may be obtained according to the embodiment shown in FIG. 1).

The circuit 600 substantially corresponds to the digital human facial expression generation device 500 shown in FIG. 5, where the main controller 610 in the external enclosure corresponds to the main control section of the digital human facial expression generation device 500, and the circuit portion in the attachment accessory connected to the VR host (e.g., a pad replacing the pad on the VR device) corresponds to the video capture section of the device 500. The main controller 610 may be configured to implement part or all of the digital human facial expression generation method according to the embodiment shown in FIG. 2, and optionally, to implement part or all of the digital human facial expression model generation method according to the embodiment shown in FIG. 1. The main controller 610 comprises a processing module 611, a memory 612, and an interface module 613, which correspond to the processing module 510, memory 520, and interface module 530 in FIG. 5. Therefore, the detailed description of these components may be referenced in the descriptions of the processing module 510, memory 520, and interface module 530 above, and is omitted here for brevity. To be suitable for VR devices, the synchronization controller 620, camera 630, LED light 640, and interface module (not shown) correspond to the video capture controller 550, camera 560, lighting device 570, and interface module 580 shown in FIG. 5, respectively. Therefore, the specific embodiment details for those components may be referred to the descriptions of the preceding descriptions, and are omitted here for brevity. However, since the plug-in system circuit 600 is designed for VR devices, the camera 630 typically comprises a plurality of cameras, so the synchronization controller 620 may send synchronized capture signals to all cameras. Such synchronization signals are generated by converting a fixed-frequency pulse emitted by the VR device into frame-triggering signals for initiating sequential frame capture operations in the cameras.

The attachment accessory connected to the VR host and the external enclosure may each have their own power supply or share a common power supply. Furthermore, all or part of the circuit in the external enclosure may be integrated into the attachment accessory connected to the VR host. If the whole circuit in the external enclosure is integrated in the attachment accessory connected to the VR host, the enclosure may be omitted.

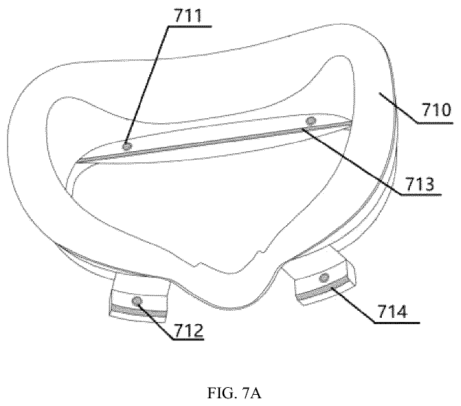

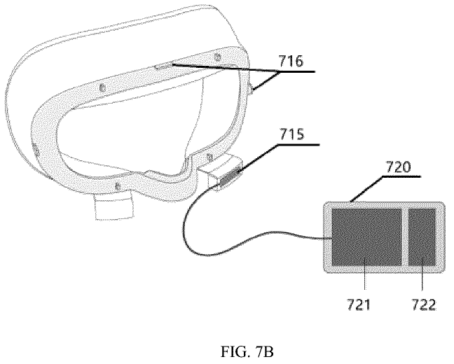

FIGS. 7A and 7B show schematic diagrams of a plug-in system for a VR device according to an embodiment of the present disclosure. FIG. 7A illustrates the attachment accessory 710 of the system connected to the VR host. The circuit arrangement of the plug-in system may be implemented using the circuit of the plug-in system shown in FIG. 6.

The plug-in system 700 comprises an attachment accessory 710 connected to the VR host and an external enclosure 720. The attachment accessory 710 may be hollow, with one surface shaped to match the surface of the VR device for easy attachment. Optionally, the attachment accessory 710 connected to the VR host contacts the user's face, replacing the pad connected to the VR host in the VR device. The attachment accessory 710 is provided with a first set of cameras 711, a second set of cameras 712, LED fill lights 713, a synchronization controller 715, and a connection structure 716. The first set of cameras 711 and LED fill lights 713 may comprise infrared cameras and infrared LED lights, respectively. Additionally, the plug-in system 700 may comprise LED fill lights 714. The strip-shaped fill lights 713/714 are designed to conform to installation contours, minimizing bulk and weight. The fill lights 713 and 714 may each comprise one or more LED lights.

The first set of cameras 711 is provided on the upper internal mounting frame of the attachment accessory 710 connected to the VR host. After the attachment accessory 710 is connected to the VR device, the first set of cameras 711 are located above the display and generally oriented to face the performer's eyes. The first set of cameras 711 is used to capture the user's eyes and expressions surrounding the eyes. As shown in FIG. 7A, the first set of cameras 711 comprises two infrared cameras (e.g., IR-enabled cameras), and more infrared cameras may be provided as needed. The frame rate of the first set of cameras 711 is no less than 30 frames per second to ensure tracking accuracy even with rapid facial movements. The infrared capability enables detection of invisible light emitted by the fill lights in low-light environments. Using infrared light to illuminate the face does not cause glare, it facilitates precise capture of subtle facial expressions. The cameras in the first set of cameras 711 are preferably symmetrically arranged.

The infrared LED fill lights 713 are provided inside the plug-in system 700 and positioned near the first set of cameras 711 to provide illumination for the eye area. For example, as shown in FIG. 7A, the lights 713 may be affixed to the lower edge of the mounting frame of the first set of cameras 711.

The second set of cameras 712 provided in the lower part of the plug-in system 700 captures the mouth and the expressions surrounding the mouth. The position of the second set of cameras 712 is such that after the plug-in system is connected to the VR device, it directly faces the performer's mouth. The second set of cameras 712 may comprise at least one camera, which may be an infrared camera or a regular camera, such as a standard high-speed camera. The camera's frame rate is preferably no less than 30 frames per second to ensure accurate tracking even with rapid facial movements. The second set of cameras 712 may be symmetrically arranged, with their shooting range covering the mouth and surrounding area. In the structure shown in FIGS. 7A and 7B, the two cameras of the second set of cameras 712 are arranged on symmetrically arranged mounting frames below the plug-in system 700.

The optional LED fill lights 714 are provided near the second set of cameras 712. For example, as shown in FIG. 7A, they may be provided on the edge of the mounting frame of the second set of cameras 712. When the second set of cameras 712 are infrared cameras, the fill lights 714 are infrared LED fill lights. When the cameras of the second set of cameras 712 are regular cameras, visible spectrum LED fill lights are provided to ensure stable illumination.

As shown in FIG. 7B, the synchronization controller 715 may be provided on the mounting structure for the second set of cameras 712 or other suitable locations. Reference may be made to the synchronization controller 620 described in FIG. 6 (omitted here for brevity). The synchronization controller 715 is configured to synchronously trigger operations of all cameras, ensuring frame-to-frame alignment during image acquisition.

The connection part 716 is provided on the side of the plug-in system 700 facing the VR device. The connection part 716 may be a snap-fit structure, comprising a plurality of protrusions, designed for compatibility with widely-used VR devices. Alternative connection methods may also be employed, provided they enable secure attachment between the plug-in system and the VR device. Optionally, the interfacing surfaces of the external accessory and the VR device can be closely fitted together.

The external box 720 comprises the main controller 721 and the power supply 722. For details, please refer to the description of the main controller 610 and the power supply in FIG. 6 above; these will not be repeated here.

The plug-in system for VR devices provided by the embodiments of the present disclosure integrates facial expression capture functionality into VR glasses. By using small, high-performance cameras and fill lights, the volume of the VR glasses does not need to be increased, achieving product lightweighting.

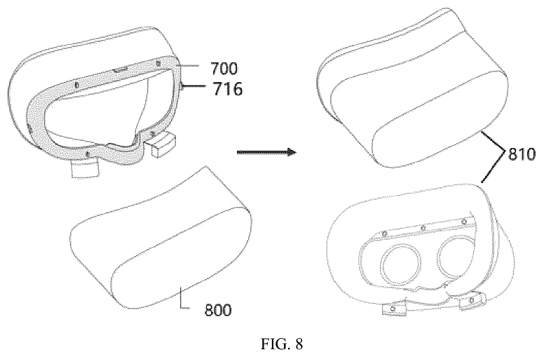

FIG. 8 is a schematic diagram of the pre-assembly and post-assembly configurations of the plug-in system 700 shown in FIGS. 7A and 7B with VR headsets.

As seen in FIG. 8, the plug-in system 700 replaces the existing facial pad of the VR glass, forming a modified VR device 810 with integrated facial expression capture functionality. By using compact, high-performance cameras and configuring the fill lights and cameras as described earlier, the system maintains the original device volume while significantly improving user immersion through precise expression tracking. By replacing the existing pad of the VR glasses, users may leverage this upgraded functionality without purchasing additional hardware, thereby reducing overall costs.

To more accurately track facial expressions, the above embodiments use more than one camera for the eye and mouth areas to capture facial animation data, achieving finer expression capture. Furthermore, using infrared cameras and infrared LED fill lights enables fast and complete capture of facial expression animations in dark environments. This allows the user or other users to see the virtual avatar's expressions in real-time, providing a better user experience.

The above are only exemplary embodiments of the present disclosure and are not intended to limit the scope of the present disclosure. The scope of the present disclosure is defined by the appended claims.

What is claimed is:

1. A method for generating digital human facial expressions, comprising:
capturing a performer's facial expression video;
selecting a plurality of frames from the facial expression video and fitting each selected frame by using an active appearance model to obtain a plurality of facial marks;
calculating values of controllers for driving expressions of 3D model of a digital human, based on the plurality of facial marks obtained from each selected frame and a pre-determined mapping relationship from facial expressions to the 3D model;
wherein determining the active appearance model comprises the following steps:
training a shape model and a texture model based on a plurality of facial marks annotated in a training set, and
obtaining a regression matrix through perturbation experiments, wherein the regression matrix represents the relationship between parameter variations obtained from the perturbation experiments and texture residual(s), and the training set comprises a plurality of images containing facial expressions.

2. The method for generating digital human facial expressions according to claim 1, wherein determining the mapping relationship from the facial expressions to the 3D model comprises:
adjusting the values of the controllers for each facial expression in the training set to obtain a corresponding expression of the digital human with high similarity;
determining the mapping relationship from the facial expressions to the 3D model based on the adjusted values of the controllers and coordinates of the annotated facial marks in the training set.

3. The method for generating digital human facial expressions according to claim 1, wherein the step of fitting each selected frame by using the active appearance model to obtain the plurality of facial marks comprises:
(1) determining texture features based on predetermined initialization reference marks;
(2) calculating difference between the texture features and the average texture features as texture residual(s), and adjusting the parameters of the texture model to obtain new average texture features;
(3) determining a parameter variation matrix based on the regression matrix and the texture residual(s) to derive shape parameters and new texture features,
iterating steps (2) and (3) until the texture residual(s) exceed a predetermined threshold or the maximum number of iterations is reached.

4. The method for generating digital human facial expressions according to claim 3, wherein the parameters of the texture model are adjusted using the following equation of the texture model:
$$g = \overline{g} + {ϕ}_{g} {b}_{g}$$
where g is the texture feature, g̅ is the average texture feature, Φ_{g} is the basis vector of texture feature space, and b_{g} is the parameter of the texture model, represented by eigenvalue of the texture feature model.

5. The method for generating digital human facial expressions according to claim 1, wherein the step of calculating the values of the controllers for driving expressions of the 3D model of the digital human comprises substituting the coordinates of the plurality of facial marks into the following equation to obtain the values of the controllers:
$${\underbrace{[ \begin{matrix}{φ}_{11} & {φ}_{12} & … & {φ}_{1 N} \\ {φ}_{21} & {φ}_{22} & … & {φ}_{2 N} \\ ⋮ & ⋮ & & ⋮ \\ {φ}_{11} & {φ}_{12} & … & {φ}_{1 N}\end{matrix} ]}}_{Φ} {\underbrace{[ \begin{matrix}{w}_{1} \\ {w}_{2} \\ ⋮ \\ {w}_{N}\end{matrix} ]}}_{w} = {\underbrace{[ \begin{matrix}{y}_{1} \\ {y}_{2} \\ ⋮ \\ {y}_{N}\end{matrix} ]}}_{y}$$
where φ is a basis function, φⱼᵢ=φ(∥xⱼ−xᵢ∥), x represents the coordinates of the plurality of facial marks, N is the number of selected frames, and y represents the values of the controllers;
the weights ware pre-calculated using the equation based on the annotated facial marks in the training set, as the mapping relationship from the facial expressions to the 3D model.

6. The method for generating digital human facial expressions according to claim 1, wherein the perturbation experiments comprise variations in perturbation values of scaling, perturbation values of rotation angle, perturbation values of translation, perturbation values of shape model parameter, and perturbation values of texture model parameter.

7. The method for generating digital human facial expressions according to claim 1, wherein the plurality of images contained in the training set are selected as a plurality of keyframes from a pre-obtained facial expression video.

8. The method for generating a digital human facial expression according to claim 2, wherein training the shape model comprises aligning the coordinates of the facial marks in the training set with average reference marks and performing principal component analysis on the transformed training set to obtain the shape model.

9. The method for generating a digital human facial expression according to claim 8, wherein the average reference mark is obtained by: (1) calculating initialized average reference marks; (2) aligning the facial marks in the training set with the average reference marks and averaging the aligned facial marks to obtain updated average reference marks; iterating step (2) until the error between the facial marks in the training set and the average reference marks is within a tolerance range.

10. A method for generating a digital human facial expression model, comprising:
training a shape model and a texture model based on a plurality of facial marks annotated in a training set;
obtaining a regression matrix through perturbation experiments, wherein the regression matrix represents the relationship between parameter variations obtained from the perturbation experiments and texture residual(s), and the training set comprises a plurality of images containing human facial expressions as keyframes;
adjusting the values of controllers for each keyframe's expression to obtain a corresponding expression of the digital human with high similarity, where the controllers are used to control the expressions of 3D model;
determining the mapping relationship from the facial expressions to the 3D model based on the adjusted values of the controllers and coordinates of the annotated facial marks.

11. The method for generating a digital human facial expression model according to claim 10, wherein the perturbation experiments comprise one or more of variations in perturbation values of scaling, perturbation values of rotation angle, perturbation values of translation, perturbation values of shape model parameter, and perturbation values of texture model parameter.

12. The method for generating a digital human facial expression model according to claim 10, wherein the step of determining the mapping relationship from the facial expressions to the 3D model based on the adjusted values of the controllers and coordinates of the annotated facial marks comprises using the following equation for fitting:
$${\underbrace{[ \begin{matrix}{φ}_{11} & {φ}_{12} & … & {φ}_{1 N} \\ {φ}_{21} & {φ}_{22} & … & {φ}_{2 N} \\ ⋮ & ⋮ & & ⋮ \\ {φ}_{11} & {φ}_{12} & … & {φ}_{1 N}\end{matrix} ]}}_{Φ} {\underbrace{[ \begin{matrix}{w}_{1} \\ {w}_{2} \\ ⋮ \\ {w}_{N}\end{matrix} ]}}_{w} = {\underbrace{[ \begin{matrix}{y}_{1} \\ {y}_{2} \\ ⋮ \\ {y}_{N}\end{matrix} ]}}_{y}$$
where φ is the basis function, φⱼᵢ=φ(∥xⱼ−xᵢ∥), x represents the coordinates of the plurality of facial marks, N is the number of keyframes, and y represents the values of the controllers;
a set of weights w is obtained for each keyframe by solving the above equation, and the weights for the plurality of keyframes are used as the mapping relationship from the human facial expression to the 3D model of the digital human.

13. The method for generating a digital human facial expression model according to claim 10, wherein training the shape model comprises aligning the coordinates of the facial marks in the training set with average reference marks and performing principal component analysis on the transformed training set to obtain the shape model.

14. The method for generating a digital human facial expression model according to claim 13, wherein the average reference mark is obtained by: (1) calculating initialized average reference marks; (2) aligning the facial marks in the training set with the average reference marks and averaging the aligned facial marks to obtain updated average reference marks; iterating step (2) until the error between the facial marks in the training set and the average reference marks is within a tolerance range.

15. The method for generating a digital human facial expression model according to claim 10, wherein the training set comprises a plurality of keyframes selected from a pre-obtained facial expression video.

16. The method for generating a digital human facial expression model according to claim 10, wherein the value of each controller indicates the intensity of a specific expression of the digital human.

17. A device for generating digital human facial expressions, comprising: at least one memory comprising instructions; and at least one processor coupled to the at least one memory and configured to:
select a plurality of frames from facial expression video and fitting each selected frame by using an active appearance model to obtain a plurality of facial marks;
calculate values of controllers for driving expressions of 3D model of a digital human, based on the plurality of facial marks obtained from each selected frame and a pre-determined mapping relationship from facial expressions to the 3D model.

18. The device for generating digital human facial expressions according to claim 17, wherein the at least one processor is configured to train a shape model and a texture model based on a plurality of facial marks annotated in a training set, and obtain a regression matrix through perturbation experiments, wherein the regression matrix represents the relationship between parameter variations obtained from the perturbation experiments and texture residual(s), and the training set comprises a plurality of images containing facial expressions.

19. The device for generating digital human facial expressions according to claim 17, wherein the at least one processor is configured to adjust the values of the controllers for each facial expression in the training set to obtain a corresponding expression of the digital human with high similarity;
determine the mapping relationship from the facial expressions to the 3D model based on the adjusted values of the controllers and coordinates of the annotated facial marks in the training set.

20. The device for generating digital human facial expressions according to claim 17, wherein the at least one processor is configured to
(1) determine texture features based on predetermined initialization marks;
(2) calculate difference between the texture features and the average texture features as texture residual(s), and adjusting the parameters of the texture model to obtain new average texture features;
(3) determine a parameter variation matrix based on the regression matrix and the texture residual(s) to derive shape parameters and new texture features,
iterate steps (2) and (3) until the texture residual(s) exceed a predetermined threshold or the maximum number of iterations is reached so as to obtain the plurality of facial marks.
